(19) United States
(12) Patent Application Publication
(10) Pub. No.: US 2005/0157230 A1
(43) Pub. Date: Jul. 21, 2005

(54) Transflective liquid crystal display device

(75) Inventors: Chiu-Lien Yang, Miao-Li (TW); Jia-Pang Pang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/026,074

(22) Filed: Dec. 30, 2004

(30) Foreign Application Priority Data
Jan. 16, 2004 (TW) 093101187

(51) Int. Cl. G02F 1/1335

(52) U.S. Cl. 349/114; 349/96

(57) ABSTRACT

A transflective liquid crystal display (TR-LCD) (2) includes a first substrate (22) and a second substrate (29) disposed opposite each other and spaced apart a predetermined distance. A liquid crystal layer (200) is interposed between the first substrate and the second substrate. A color filter layer (20), a common electrode (28), a first polarizer (24) and a first alignment film (26) are positioned on an inner surface of the first substrate. A transflective layer (21), a second polarizer (27) and a second alignment film (25) are positioned on an inner surface of the second substrate. The second polarizer is an extraordinary type polarizer. The polarizers are made of a modified organic dye material which exists in a liquid-crystalline phase, thereby enabling the TR-LCD to work in temperatures up to 200 degrees Centigrade.

### CROSS REFERENCE TO RELATED APPLICATIONS

This application is related to co-pending applications entitled “Color filter on array mode liquid crystal display and method for making the same” and “In-plane field type transflective liquid crystal display device,” both of which are assigned to the same assignee as this application.

### BACKGROUND OF THE INVENTION

1. Field of the Invention

The present invention relates to liquid crystal displays (LCDs), and especially to a transflective liquid crystal display (TR-LCD) having at least one extraordinary type polarizer.

2. Description of Prior Art

Due to the features of being thin and consuming little power, liquid crystal display devices have been used in a broad range of fields. Applications include office automation (OA) apparatuses such as word processors and personal computers, portable information apparatuses such as portable electronic schedulers, videocassette recorders (VCRs) provided with information panels, and mobile phones provided with liquid crystal monitors.

Unlike with a cathode ray tube (CRT) display or an electroluminescence (EL) display, the liquid crystal display screen of a liquid crystal display device does not emit light itself. Instead, in a conventional transmission type liquid crystal display device, an illuminator called a backlight is provided at a rear or one side of the liquid crystal display device. The amount of light received from the backlight which passes through the liquid crystal panel is controlled by the liquid crystal panel, in order to obtain images for display.

In the transmission type liquid crystal display device, the backlight consumes 50% or more of the total power consumed by the liquid crystal display device. That is, the backlight is a major contributor to power consumption.

In order to overcome the above problem, a reflection type liquid crystal display device has been developed for portable information apparatuses which are often used outdoors or in places where artificial ambient light is available. The reflection type liquid crystal display device is provided with a reflector formed on one of a pair of substrates, instead of having a backlight. Ambient light is reflected from a surface of the reflector to illuminate the display screen.

The reflection type liquid crystal display device using the reflection of ambient light is disadvantageous, insofar as the visibility of the display screen is extremely low when the surrounding environment is dark. Conversely, the transmission type liquid crystal display device is disadvantageous when the surrounding environment is bright. That is, the color reproduction is low and the display screen is not sufficiently clear because the display brightness is only slightly less than the brightness of the ambient light. In order to improve the display quality in a bright surrounding environment, the intensity of the light from the backlight needs to be increased. This increases the power consumption of the backlight and reduces the efficiency of the liquid crystal display device. Moreover, when the liquid crystal display device needs to be viewed at a position exposed to direct sunlight or direct artificial light, the display quality is generally lower. For example, when a display screen fixed in a car or a display screen of a personal computer receives direct sunlight or artificial light, surrounding images are reflected from the display screen. This makes it difficult to observe the images of the display screen itself.

In order to overcome the above problems, an apparatus which realizes both a transmission mode display and a reflection mode display in a single liquid crystal display device has been developed. The apparatus is called as a transflective liquid crystal display. Referring to FIG. 9, a conventional TR-LCD 1 comprises an upper substrate 12 and a lower substrate 19 disposed opposite to each other and spaced apart a predetermined distance. A liquid crystal layer 100 having a multiplicity of liquid crystal molecules (not labeled) is disposed between the upper and lower substrates 12, 19. A backlight module (not shown) is disposed under the lower substrate 19, for providing illumination for the TR-LCD 1.

A indium tin oxide (ITO) pixel electrode layer 13 and an alignment film 15 are positioned on an inner surface of the lower substrate 19, in that order from bottom to top. A color filter layer 10, a common electrode layer 18 and an alignment film 16 are positioned on an inner surface of the upper substrate 12, in that order from top to bottom. Two polarizers 14, 17 are positioned on outer surfaces of the upper substrate 12 and the lower substrate 19, respectively. The polarizers 14, 17 are ordinary type polarizers, and are made of polyvinyl alcohol (PVA). The polarizers 14, 17 function to allow passage of ordinary polarized light beams, while blocking extraordinary polarized light beams. Polarizing axes of the polarizers 14, 17 are perpendicular to each other; that is, the polarizers 14, 17 are crossed polarizers. A transflector 11 is positioned under the polarizer 17.

When the TR-LCD 1 is driven, an electric field is formed between the common electrode layer 18 and the pixel electrode layer 13 at each pixel. The liquid crystal molecules disposed between the common electrode layer 18 and pixel electrode layer 13 are all driven, thus giving the TR-LCD 1 displayed images.

However, because the polarizers 14 and 17 are made of PVA, they cannot work at temperatures higher than 80 degrees Centigrade. This limits the range of apparatuses and environments in which the TR-LCD 1 can be applied. In addition, because the polarizers 14, 17 are positioned at outer surfaces of the TR-LCD 1, they are easily damaged or even destroyed in handling or in use. Furthermore, in manufacturing of the TR-LCD 1, the polarizers 14 and 17 are typically separate parts having protecting films. In the last step of manufacturing, the polarizers 14 and 17 are adhered on the LCD panel. This makes the TR-LCD 1 unduly thick and bulky.

Moreover, the color filter layer 10 has a de-polarizing effect on light beams passing therethrough, due to pigment light scattering. That is, light beams passing through the TR-LCD 1 are at least partially de-polarized by the color filter layer 10 before reaching the polarizer 14. This de-polarizing of the light beams can reduce the contrast ratio of the TR-LCD 1. Even though such de-polarizing effects are generally small, they can have a significant effect on the contrast ratio of the TR-LCD 1.

It is desired to provide a TR-LCD that can solve the above-mentioned problems.

### SUMMARY OF THE INVENTION

An object of the present invention is to provide a transflective liquid crystal display which can work at high temperatures, and which is relatively thin and compact.

Another object of the present invention is to provide a transflective liquid crystal display which achieves a good contrast ratio.

Still another object of the present invention is to provide a transflective liquid crystal display which resists damage that might occur because of contamination or foreign matter.

A transflective liquid crystal display (TR-LCD) of the present invention includes a first substrate and a second substrate disposed opposite each other and spaced apart a predetermined distance. A liquid crystal layer interposed between the first substrate and the second substrate. A color filter layer, a common electrode, a first polarizer and a first alignment film are positioned on an inner surface of the first substrate. A transflective layer, a second polarizer and a second alignment film are positioned on an inner surface of the second substrate. The second polarizer is an extraordinary type polarizer.

The polarizers are made of a modified organic dye material which exists in a liquid-crystalline phase. Therefore the TR-LCD can work in temperatures up to 200 degrees Centigrade, and have a broader range of applications in the TR-LCD marketplace. Furthermore, each polarizer has a thickness of less than 100 microns.

Moreover, the color filter layer is positioned on the first substrate over the first polarizer. This arrangement reduces or eliminates the adverse effects of color filter de-polarizing, and yields a higher contrast ratio.

Other objects, advantages, and novel features of the present invention will become more apparent from the following detailed description when taken in conjunction with the accompanying drawings, in which:

### BRIEF DESCRIPTION OF THE DRAWINGS

FIG. 1 is a schematic, cross-sectional view of one pixel region of a TR-LCD according to a first exemplary embodiment of the present invention;

FIG. 2A-2C are enlarged, isometric views of three different embodiments of transflective layers of the TR-LCD of FIG. 1, showing essential optical paths thereof;

FIG. 3 is similar to FIG. 1, showing essential optical paths when the TR-LCD is working in a transmissive mode with no voltage applied;

FIG. 4 is similar to FIG. 3, but showing essential optical paths when the TR-LCD is working in a transmissive mode with a voltage applied;

FIG. 5 is similar to FIG. 1, showing an essential optical path when the TR-LCD is working in a reflective mode with no voltage applied;

FIG. 6 is similar to FIG. 5, but showing an essential optical path when the TR-LCD is working in a reflective mode with a voltage applied;

FIG. 7 is a schematic, cross-sectional view of one pixel region of a TR-LCD according to a second exemplary embodiment of the present invention;

FIG. 8 is a schematic, cross-sectional view of one pixel region of a TR-LCD according to a third exemplary embodiment of the present invention; and

FIG. 9 is a schematic, cross-sectional view of one pixel region of a conventional TR-LCD.

### DETAILED DESCRIPTION OF THE INVENTION

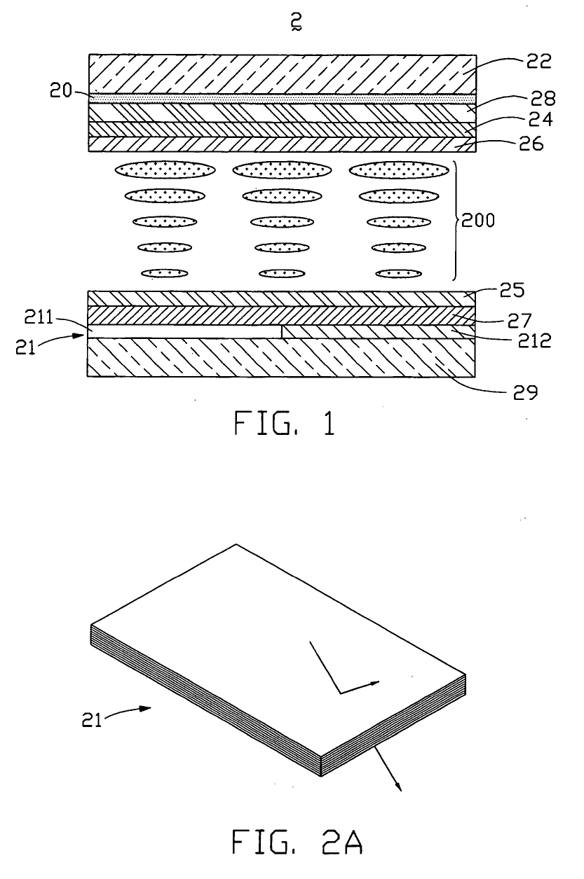

Referring to FIG. 1, a transflective liquid crystal display (TR-LCD) 2 according to the first exemplary embodiment of the present invention comprises a first substrate 22, a second substrate 29, and a liquid crystal layer 200 having a multiplicity of liquid crystal molecules (not labeled). A backlight module (not shown) is disposed under the second substrate 29. The first substrate 22 and the second substrate 29 are spaced apart from each other, and the liquid crystal layer 200 is disposed therebetween. The first substrate 22 and the second substrate 29 are made of glass. Alternatively, the first substrate 22 and the second substrate 29 can be made of silicon dioxide (SiO₂).

A color filter layer 20, a common electrode 28, a first polarizer 24 and a first alignment film 26 are positioned on an inner surface of the first substrate 22, in that order from top to bottom. A transflective layer 21, a second polarizer 27 and a second alignment film 25 are positioned on an inner surface of the second substrate 29, in that order from bottom to top. The second substrate 29 may comprise a thin film transistor (TFT) array (not shown) connecting with the transflective layer 21.

The common electrode 28 is plate-shaped, and is made of a transparent conductor. A material of the transparent conductor can, for example, be indium tin oxide (ITO) or indium zinc oxide (IZO). The alignment films 25, 26 are alignment layers for orientating the liquid crystal molecules. The color filter 20 comprises a black matrix (not shown), and a color resin layer having Red, Green and Blue segments. The black matrix is disposed between the segments of the color resin layer, to prevent light beams from leaking.

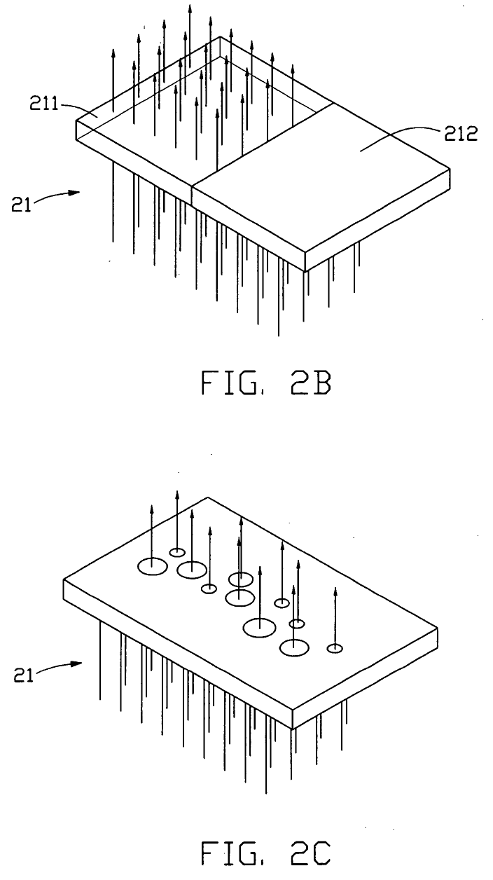

The transflective layer 21 functions as a pixel electrode, and includes a plurality of transmission areas 211 and a plurality of reflective areas 212. The transmission areas 211 and reflective areas 212 each have a conductive layer and a dielectric layer. The dielectric layer comprises one or more stacks of dielectric materials, with each stack comprising a plurality of thin film dielectric layers (see FIG. 2A). The reflection and transmission of the transflective layer 21 can be controlled by adjusting the number of layers, the refractive indexes and/or the thicknesses of the thin film dielectric layers in the stacks. Alternatively, the transmission areas 211 can be made of a translucent conductive material such as indium tin oxide (ITO) or indium zinc oxide (IZO), and the reflective areas 212 can be made of a highly reflective conductive material such as aluminum (see FIG. 2B). In a further alternative embodiment, the transflective layer 21 can have one or more holes therein (see FIG. 2C).

A single reflective area 212 and an adjacent single transmission area 211 cooperatively define a single pixel region or part of a single pixel region. In the illustrated embodiment, for simplicity, it is assumed that a single reflective area 212 and an adjacent single transmission area 211 cooperatively define a single pixel region. Each pixel region thus comprises one transmission region and one reflection region. Accordingly, a plurality of pixel regions are defined by respective pairs of reflective areas 212 and the transmission areas 211. In manufacturing, a ratio of areas of the reflective area 212 and the transmission area 211 is configured so that the transflective layer 21 can transmit backlight and can reflect ambient light. Thus the TR-LCD 2 provides a transflective display that works in both a transmission mode and a reflection mode.

The polarizers 24, 27 are both extraordinary type polarizers composed of mixtures of narrow-band components. Each component comprises a modified organic dye material which exists in a liquid-crystalline phase. Polarizing axes of the polarizers 24, 27 are perpendicular to each other; that is, the polarizers 24, 27 are crossed polarizers. The polarizers 24, 27 pass extraordinary polarized light beams, while blocking ordinary polarized light beams. A thickness of each of the polarizers 24, 27 is less than 100 microns. This ensures that the operating voltage of the TR-LCD 2 is not affected when the polarizers 24, 27 are formed at inner surfaces of the first substrate 22 and the second substrate 29, respectively.

Referring to FIG. 3, when the display works in a transmission mode, and when no voltage is applied to the common electrode 28 and the transflective layer 21, the liquid crystal molecules are oriented along directions according to the first and second alignment films 26 and 25. Long axes of the liquid crystal molecules at the first substrate 22 are oriented more than 90 degrees differently from long axes of the liquid crystal molecules at the second substrate 29. The state of polarization of light beams is changed when the light beams pass from the backlight module through the liquid crystal layer 200. Therefore, these light beams can pass through the first polarizer 24 formed at the first substrate 22. As a result, the TR-LCD 2 is in a bright state.

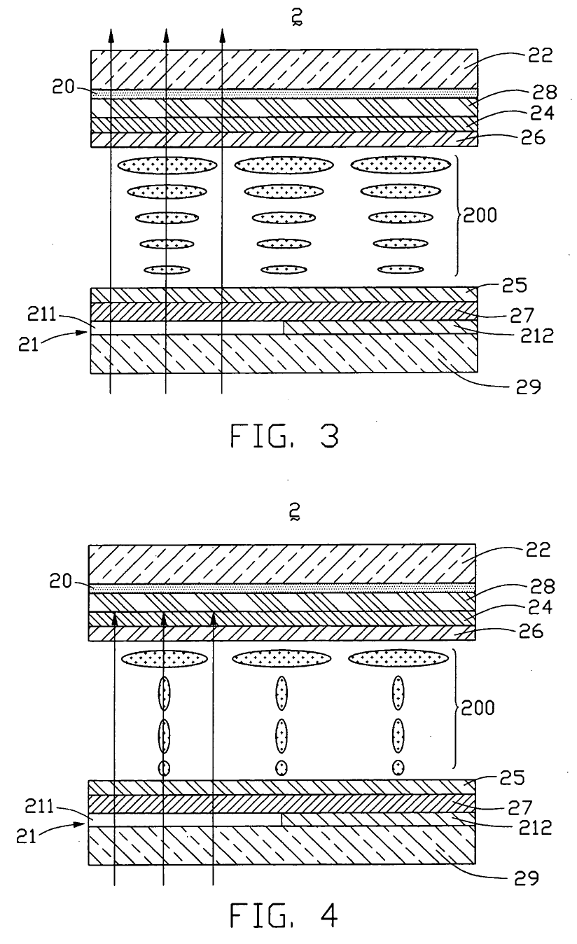

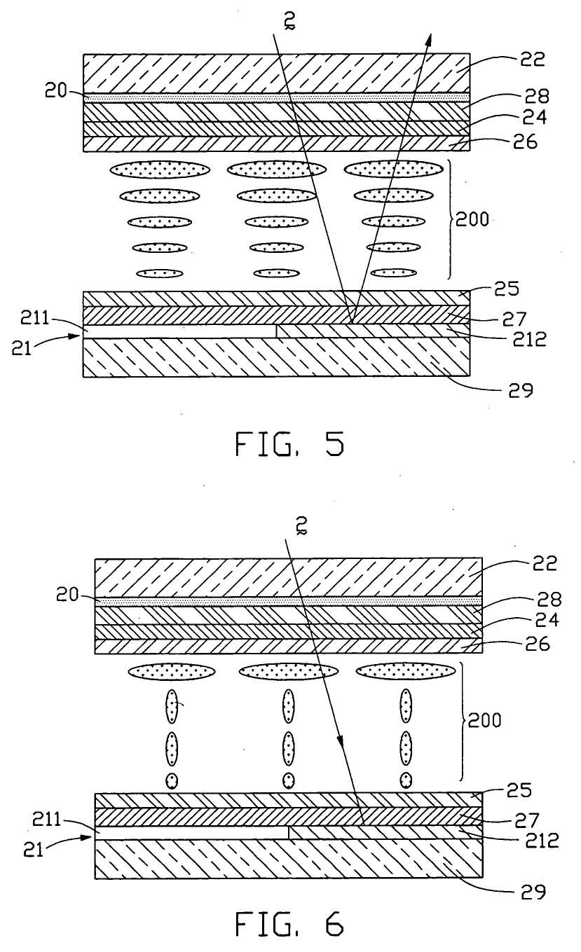

Referring to FIG. 4, when a voltage is applied to the common electrode 28 and the transflective layer 21, an electric field is produced therebetween at each pixel region. The long axes of the liquid crystal molecules are oriented parallel to the electric field. The state of polarization of the light beams does not change when the light beams pass from the backlight module through the liquid crystal layer 200. Therefore the light beams cannot pass through the first polarizer 24. As a result, the TR-LCD 2 is in a dark state.

Referring to FIG. 5, when the display works in a reflective mode, and when no voltage is applied to the common electrode 28 and the transflective layer 21, the liquid crystal molecules are oriented along directions according to the first and second alignment films 26 and 25. Long axes of the liquid crystal molecules at the first substrate 22 are oriented more than 90 degrees differently from long axes of the liquid crystal molecules at the second substrate 29. The state of polarization of light beams is changed when the light beams pass from the ambient environment through the liquid crystal layer 200. Therefore, these light beams can pass through the second polarizer 27 formed at the second substrate 29, and are reflected by the reflective area 212 back through the first polarizer 24 formed at the first substrate 22. As a result, the TR-LCD 2 is in a bright state.

When a voltage is applied to the common electrode 28 and the transflective layer 21, an electric field is produced therebetween at each pixel region. The long axes of the liquid crystal molecules are oriented parallel to the electric field. Light beams from the ambient environment pass through the liquid crystal layer 200. The state of polarization of the light beams does not change when the light beams pass from the ambient environment through the liquid crystal layer 200. Therefore the light beams cannot pass through the second polarizer 27. As a result, the TR-LCD 2 is in a dark state.

The extraordinary type polarizers 24, 27, are positioned within the liquid crystal cell of the TR-LCD 2, and each polarizer 24, 27 has a thickness of less than 100 microns. Thus the TR-LCD 2 resists damage that might occur because of contamination or foreign matter, and is thin and compact. The TR-LCD 2 is ideal for use in a touch LCD panel, because only a touch layer needs to be positioned thereon. Furthermore, the polarizers 24, 27 are made of a modified organic dye material which exists in a liquid-crystalline phase. Therefore the TR-LCD 2 can work in temperatures up to 200 degrees Centigrade, and have a broader range of applications in the LCD marketplace.

Moreover, the color filter layer 20 is positioned on the first substrate 22 over the first polarizer 24. This arrangement reduces or eliminates the adverse effects of color filter de-polarizing, and yields a higher contrast ratio.

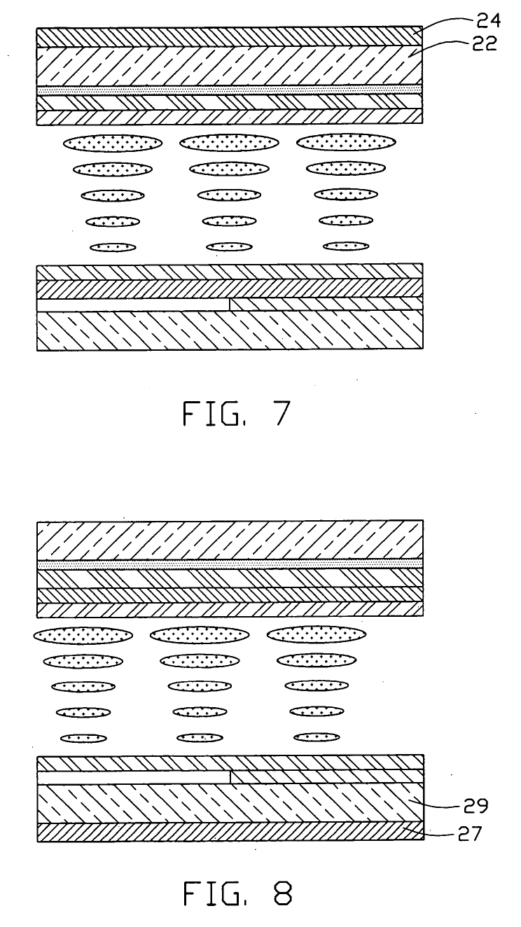

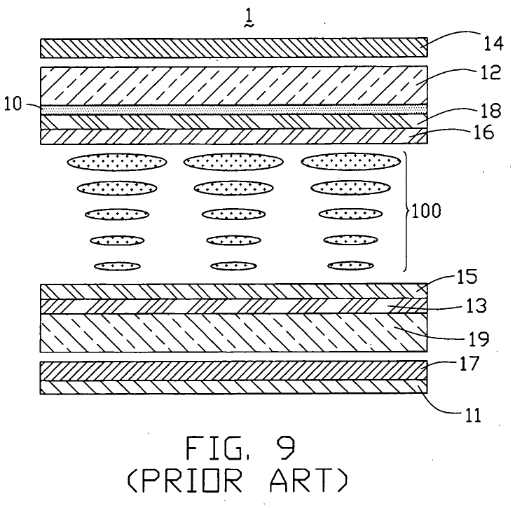

Referring to FIGS. 7 and 8, these show second and third exemplary embodiments of the present invention respectively. Each of the second and third exemplary embodiments is a variation of the configuration of the TR-LCD device 2 of the first exemplary embodiment. In the second exemplary embodiment, the first polarizer 24 is positioned on an outer surface of the first substrate 22, as shown in FIG. 7. In the third exemplary embodiment, the second polarizer 27 is positioned on an outer surface of the second substrate 29, as shown in FIG. 8.

It is to be further understood, however, that even though numerous characteristics and advantages of the present invention have been set out in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1. A transflective liquid crystal display comprising:
a first substrate and a second substrate disposed opposite each other and spaced apart a predetermined distance;
a liquid crystal layer interposed between the first substrate and the second substrate;
a color filter layer, a common electrode, a first polarizer and a first alignment film positioned on the first substrate; and
a transflective layer, a second polarizer and a second alignment film positioned on the second substrate;
wherein the second polarizer is an extraordinary type polarizer.

2. The transflective liquid crystal display as claimed in claim 1, wherein the first polarizer is an extraordinary type polarizer.

3. The transflective liquid crystal display as claimed in claim 2, wherein the first and second polarizers are positioned at inner surfaces of the first and second substrates, respectively.

4. The transflective liquid crystal display as claimed in claim 3, wherein the first and second polarizers are made of a modified organic dye material which exists in a liquid crystalline phase.

5. The transflective liquid crystal display as claimed in claim 4, wherein each of the first and second polarizers has a thickness of less than 100 microns.

6. The transflective liquid crystal display as claimed in claim 1, wherein the color filter layer is positioned on the first substrate over the first polarizer, for eliminating or reducing any adverse effects of color filter de-polarizing.

7. The transflective liquid crystal display as claimed in claim 1, wherein polarizing axes of the upper polarizer and the lower polarizer are perpendicular to each other.

8. The transflective liquid crystal display as claimed in claim 1, wherein the transflective layer functions as a pixel electrode, and includes a plurality of transmission areas and a plurality of reflective areas.

9. The transflective liquid crystal display as claimed in claim 8, wherein the transmission areas and reflective areas each have a conductive layer and a dielectric layer, the dielectric layer comprises one or more stacks of dielectric materials, with each stack comprising a plurality of thin film dielectric layers.

10. The transflective liquid crystal display as claimed in claim 8, wherein the transmission areas are made of indium tin oxide or indium zinc oxide, and the reflective areas are made of a highly reflective conductive material.

11. The transflective liquid crystal display as claimed in claim 1, wherein the transflective layer has one or more holes therein.

12. The transflective liquid crystal display as claimed in claim 1, wherein the common electrode is made of indium tin oxide.

13. The transflective liquid crystal display as claimed in claim 1, wherein the common electrode is made of indium zinc oxide.

14. The transflective liquid crystal display as claimed in claim 1, wherein the second substrate comprises a thin film transistor array connecting with the transflective layer.

15. A transflective liquid crystal display comprising:
a first substrate and a second substrate disposed opposite each other and spaced apart a predetermined distance;
a liquid crystal layer interposed between the first substrate and the second substrate;
a color filter layer, a common electrode, a first polarizer and a first alignment film positioned on the first substrate; and
a transflective layer, a second polarizer and a second alignment film positioned on the second substrate;
wherein at least one of said first polarizer and said second polarizer is located between the first substrate and the second substrate.

16. A transflective liquid crystal display comprising:
a first substrate and a second substrate disposed opposite each other and spaced apart a predetermined distance;
a liquid crystal layer interposed between the first substrate and the second substrate;
a color filter layer, a common electrode, a first polarizer and a first alignment film positioned on the first substrate; and
a transflective layer, a second polarizer and a second alignment film positioned on the second substrate;
wherein at least one of the first polarizer and the second polarizer is an extraordinary type polarizer.
